(19) United States
(12) Patent Application Publication
(10) Pub. No.: US 2024/0302096 A1
(43) Pub. Date: Sep. 12, 2024

(54) ROLLER SPINNING APPARATUS

(71) Applicant: Robert L. Couch, Knoxville, TN (US)

(72) Inventor: Robert L. Couch, Knoxville, TN (US)

(21) Appl. No.: 18/601,136

(22) Filed: Mar. 11, 2024

Related U.S. Application Data
(60) Provisional application No. 63/515,703, filed on Jul. 26, 2023.
(60) Provisional application No. 63/489,260, filed on Mar. 9, 2023.

(51) Int. Cl. F26B 5/08

(52) U.S. Cl. CPC F26B 5/08; B44D 3/006

(57) ABSTRACT

A roller spinning assembly includes a roller frame and a spindle connected to the roller frame. The spindle is “locked” to the roller frame such that the spindle does not rotate independently of the roller frame. To clean the roller, the roller is fitted onto the roller frame, the spindle is fitted to the drill, and the roller, roller frame, and a portion of the spindle are immersed in water within a bucket. The drill spins the spindle, roller frame, and roller, and the spinning of the roller within the water acts to clean the roller quickly, removing paint and other extraneous material from the roller. The roller spinning assembly also has applications for mixing paint, as well as for mixing drywall mix and similar materials.

### CROSS-REFERENCE TO RELATED APPLICATIONS

This Application claims the benefit of the filing date of U.S. Provisional Patent Application Ser. No. 63/489,260, filed Mar. 9, 2023, and of U.S. Provisional Patent Application Ser. No. 63/515,703, filed Jul. 26, 2023; the entire contents of both provisional patent applications are incorporated herein by reference.

### BACKGROUND OF THE INVENTION

### 1. Field of Invention

The present invention pertains generally to devices and methods for cleaning painting instruments and, more particularly, to devices and methods for cleaning paint rollers, as well as for mixing paint and similar materials.

### 2. Description of the Related Art

The present general inventive concept relates generally to devices and methods for cleaning painting instruments. More particularly, the present general inventive concept pertains particularly to devices and methods for cleaning paint rollers. Paint rollers are known in the art, as are a number of existing devices and methods for cleaning such paint rollers, as for example at the conclusion of a job or a painting session.

U.S. Pat. No. 5,709,301, also by Couch, discloses storage devices for paint rollers, paint roller covers, and paint brushes. The storage devices for the paint rollers and paint roller covers are cylindrical containers, having a lid, which are flared outwardly at their upper portions and have a foam insert at the bottom for forming a spongy seal with the painting implement. The container for the cover has a core in it around which the roller cover fits. The lid, which can be either a screw down or a friction fit lid, has a foam insert on its underside to form a spongy seal with the upper part of the roller cover. The container for the roller and the lid, which must be a friction fit lid, each have a semicircular opening lined with a gasket. The mating of the container and the lid result in the formation of a circular opening through which the handle of a roller frame can extend. The paint brush holder is a rectangular-shaped container having a foam insert fitted to its upper portion. The exterior of the insert is sized to fit the container. The insert has an opening for holding a paint brush collar to allow the bristles to be in the container without touching the bottom. The insert keeps the brush wet and from drying out. The insert can be replaced with an insert having the same exterior size, which will fit the container, and a different sized interior surface, to hold another size of paint brush.

### SUMMARY

Disclosed herein are various example embodiments of the present general inventive concept. The present general inventive concept relates generally to devices and methods for cleaning painting instruments. More particularly, the present general inventive concept pertains particularly to devices and methods for cleaning paint rollers. Moreover, assemblies and methods according to example embodiments of the present general inventive concept also have applications for mixing paint, as well as for mixing drywall mix and similar materials.

Generally, a roller spinning assembly includes a roller frame and a spindle connected to the roller frame. The roller frame is adapted to interact with a paint roller such that at least some portion of the roller fits over the roller frame. One end of the spindle is adapted to be received by the chuck of a drill. The spindle is “locked” to the roller frame such that the spindle does not rotate independently of the roller frame. To clean the roller, the roller is fitted onto the roller frame, the spindle is fitted to the drill, and the roller, roller frame, and a portion of the spindle are immersed in water within a bucket. The drill spins the spindle, roller frame, and roller, and the spinning of the roller within the water acts to clean the roller quickly, removing paint and other extraneous material from the roller. The roller spinning assembly also has applications for mixing paint, as well as for mixing drywall mix and similar materials.

Thus, in some example embodiments of the present general inventive concept, a roller spinning assembly for cleaning a paint roller comprises a roller frame, and a spindle connected to the roller frame, said roller frame being adapted to interact with a paint roller such that at least some portion of the paint roller fits over the roller frame, and one end of the spindle being adapted to be received by a chuck of a drill, the spindle being locked to the roller frame such that the spindle does not rotate independently of the roller frame.

In further aspects of the present general inventive concept, a roller spinning assembly for cleaning a paint roller includes a roller frame and a spindle connected to the roller frame, the roller frame being adapted to interact with a paint roller such that at least some portion of the paint roller fits over the roller frame, and one end of the spindle being adapted to be received by a chuck of a drill, the spindle being connected to the roller frame in such a way that the spindle does not rotate independently of the roller frame.

In some embodiments, the roller frame includes a solid molded body including a central axial portion configured to fit with the spindle and a plurality of wings radiating from the central axial portion.

In some embodiments, the wings radiate from the central axial portion of the roller frame in a spiral configuration.

In some embodiments, the wings radiate from the central axial portion of the roller frame in a substantially orthogonal configuration.

In some embodiments of the present general inventive concept, a method of cleaning a paint roller includes providing a roller frame and a spindle connected to the roller frame, the roller frame is adapted to interact with a paint roller such that at least some portion of the roller fits over the roller frame, one end of the spindle being configured to be received by the chuck of a drill, and the spindle being connected to the roller frame such that the spindle does not rotate independently of the roller frame, fitting the roller is onto the roller frame, fitting the spindle is to the drill, immersing the roller, roller frame, and a portion of the spindle in water within a bucket, and spinning the spindle by activating the drill, whereby the spinning of the roller within the water acts to clean the roller quickly, removing paint and other extraneous material from the roller.

In some embodiments of the present general inventive concept, a method of cleaning a paint brush comprises connecting a paint brush with a handle to a spindle, one end of the spindle being configured to be received by the chuck of a drill, and the spindle being connected to the handle of the paint brush, fitting the spindle is to the drill, immersing the brush and a portion of the spindle in water within a bucket, and spinning the spindle by activating the drill, whereby the spinning of the brush within the water acts to clean the brush quickly, removing paint and other extraneous material from the brush.

### BRIEF DESCRIPTION OF DRAWINGS

The above-mentioned and additional features of the invention will become more clearly understood from the following detailed description of the invention read together with the drawings in which:

FIG. 1 is an exploded perspective view of an assembly according to one example embodiment of the present general inventive concept, showing an example embodiment of an assembly comprising a roller frame and an extender shaft, together with a roller and a drill;

FIG. 2 is a second perspective view of the example embodiment assembly shown in FIG. 1, showing the roller installed on the roller frame;

FIG. 3 is a perspective view showing the example embodiment assembly of FIGS. 1 and 2 proximate a bucket partially filled with water, with the roller about to be immersed in the water within the bucket;

FIG. 4 is a section view of the example embodiment shown in FIG. 3, showing the roller, the roller frame, and a portion of the extender shaft or spindle immersed in the water within the bucket;

FIG. 5 is a perspective view of the embodiment shown in FIGS. 1-4, showing how the roller frame and extender shaft is inserted into an interior volume of the roller for purposes of storage and/or transport;

FIG. 6 is a section view of the example embodiment shown in FIG. 5, showing the roller frame and extender shaft positioned within the interior volume of the roller;

FIG. 7 is a perspective view of another example embodiment of the present general inventive concept, showing an assembly with a longer roller frame;

FIG. 8 is a perspective view of another example embodiment of the present general inventive concept, showing an assembly with a roller frame and extender shaft used with an electric screwdriver;

FIG. 9A is a perspective view of a paint brush adapted to work with an example embodiment assembly according to one example embodiment of the present general inventive concept, and FIG. 9B is a perspective view of another paint brush adapted to work with another example embodiment assembly according to an example embodiment of the present general inventive concept;

FIG. 10 is a perspective view showing the example embodiment assembly of FIG. 9A proximate a bucket partially filled with water, with the paint brush about to be immersed in the water within the bucket;

FIG. 11 is a section view of the example embodiment shown in FIG. 10, showing the paint brush and a portion of the extender shaft or spindle immersed in the water within the bucket;

FIG. 12 is a perspective view of another example embodiment of the present general inventive concept, showing an assembly with a roller frame and extender shaft used with an electric screwdriver; and

FIG. 13 is a perspective view of another example embodiment of the present general inventive concept, showing an assembly with a roller frame and extender shaft used with an electric screwdriver.

### DETAILED DESCRIPTION

Reference will now be made to the example embodiments of the present general inventive concept, examples of which are illustrated in the accompanying drawings and illustrations. The example embodiments are described herein in order to explain the present general inventive concept by referring to the figures.

The following detailed description is provided to assist the reader in gaining a comprehensive understanding of the structures and fabrication techniques described herein. Accordingly, various changes, modification, and equivalents of the structures and fabrication techniques described herein will be suggested to those of ordinary skill in the art. The progression of fabrication operations described are merely examples, however, and the sequence type of operations is not limited to that set forth herein and may be changed as is known in the art, with the exception of operations necessarily occurring in a certain order. Also, description of well-known functions and constructions may be simplified and/or omitted for increased clarity and conciseness.

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.

Note that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. Spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

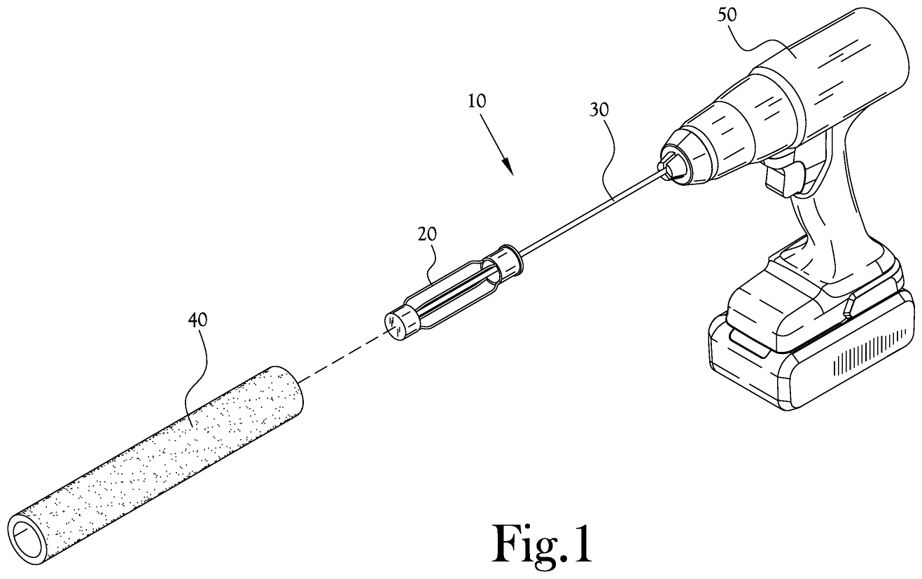

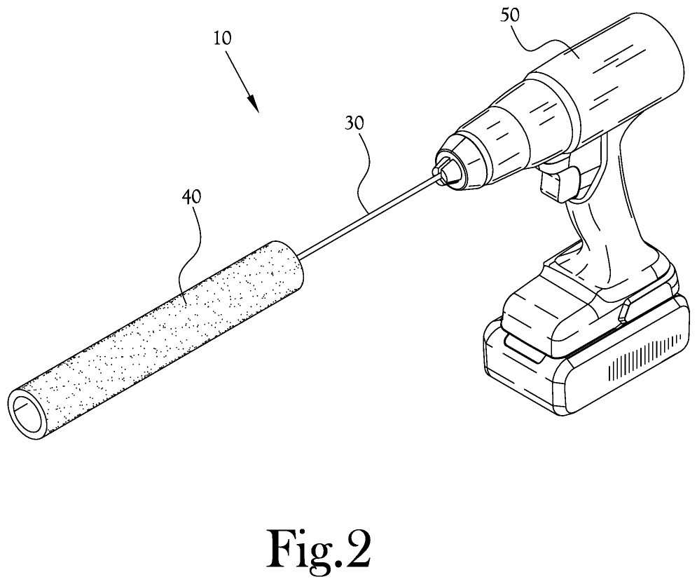

Turning to the Figures, FIG. 1 shows an exploded perspective view of an assembly according to one example embodiment of the present general inventive concept, illustrating an example embodiment of an assembly comprising a roller frame and an extender shaft, together with a roller and a drill. FIG. 2 is a second perspective view of the same example embodiment shown in FIG. 1, showing the roller installed on the roller frame. As shown in FIGS. 1 and 2, a roller spinning assembly 10 includes a roller frame 20 and a spindle, rod or extender shaft (hereinafter “spindle”) 30 connected to the roller frame 20. The roller frame 20 is adapted to interact with a paint roller 40 such that at least some portion of the roller 40 fits over the roller frame 20. One end of the spindle 30 is adapted to be received by the chuck of a drill 50. Generally, in embodiments of the present general inventive concept, the spindle 30 is affixed to the roller frame 20 such that the spindle does not rotate independently of the roller frame 20, and the roller frame 20 does not rotate on the spindle 30 (in contradistinction to many roller frames); that is, the spindle 30 is “locked” to the roller frame 20.

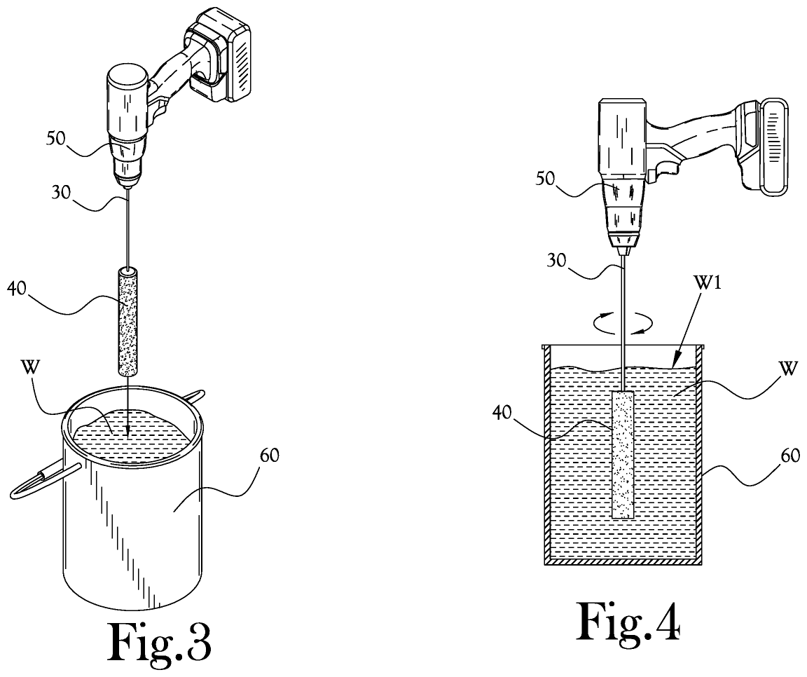

FIG. 3 is a perspective view showing the example embodiment assembly of FIGS. 1 and 2 proximate a bucket partially filled with water, with the roller about to be immersed in the water within the bucket. As shown in FIG. 3, when the roller 40 is to be cleaned, the roller 40 is fitted onto the roller frame 20 (as shown in FIG. 2), the spindle 30 is fitted to the drill 50, and the roller 40, roller frame 20, and a portion of the spindle 30 are immersed in the water W within the bucket 60. FIG. 4 illustrates in section view the roller 40, the roller frame 20, and a portion of the spindle 30 immersed in the water W within the bucket 60, with the entire roller 40 immersed beneath the surface WI of the water W in the bucket 60. The drill 50 is then used to spin the spindle 30, roller frame 20, and roller 40, and the spinning of the roller 40 within the water W acts to clean the roller 40, removing paint and other extraneous material from the roller 40.

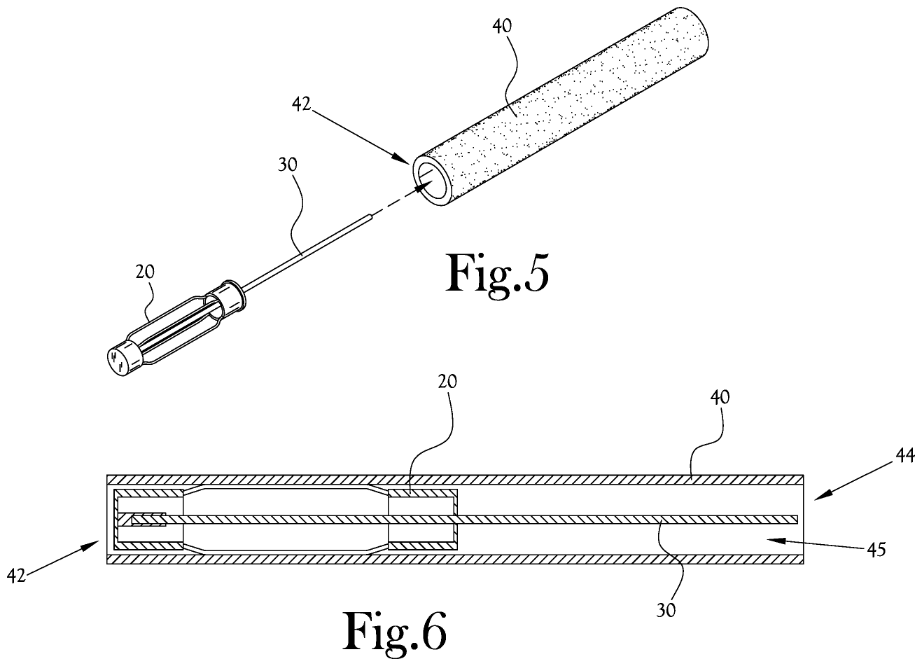

FIG. 5 is a perspective view of the embodiment shown in FIGS. 1-4, showing how the roller frame 20 and spindle 30 is inserted into an interior volume 45 of the roller 40 for purposes of storage and/or transport. Likewise, FIG. 6 is a section view of the example embodiment shown in FIG. 5, showing the roller frame 20 and spindle 30 positioned within the interior volume 45 of the roller 40. Generally, the roller frame 40 includes two open ends 42 and 44, and the roller frame 20 and spindle 30 are inserted into the roller 40 through one of the open ends.

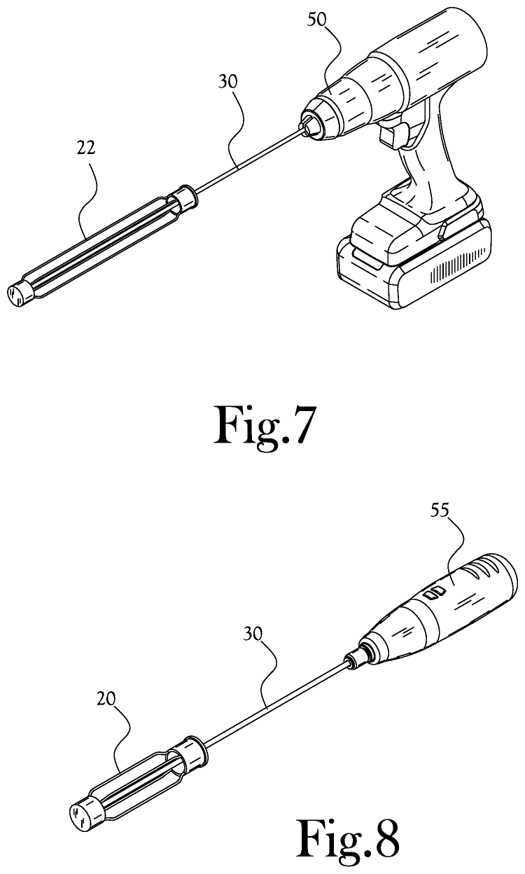

FIG. 7 is a perspective view of another example embodiment of the present general inventive concept, showing an assembly with a longer roller frame 22.

FIG. 8 is a perspective view of another example embodiment of the present general inventive concept, showing an assembly with a roller frame 20 and spindle 30 used with an electric screwdriver 55.

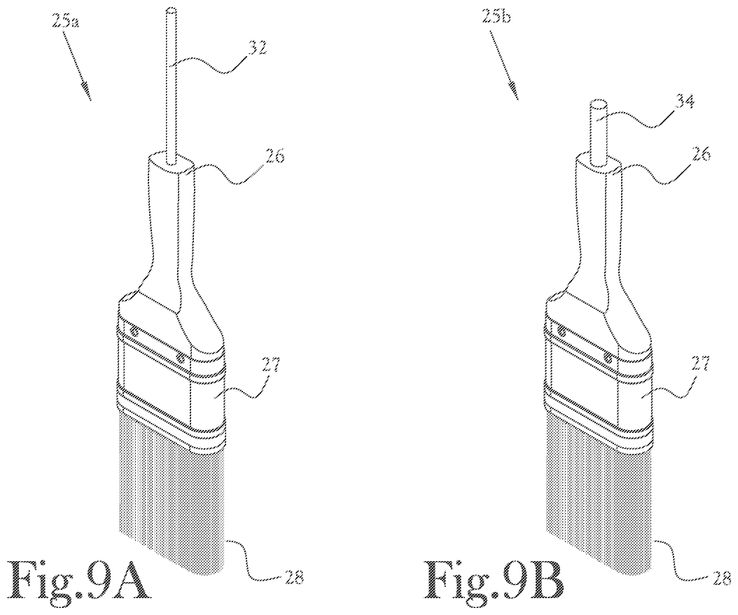

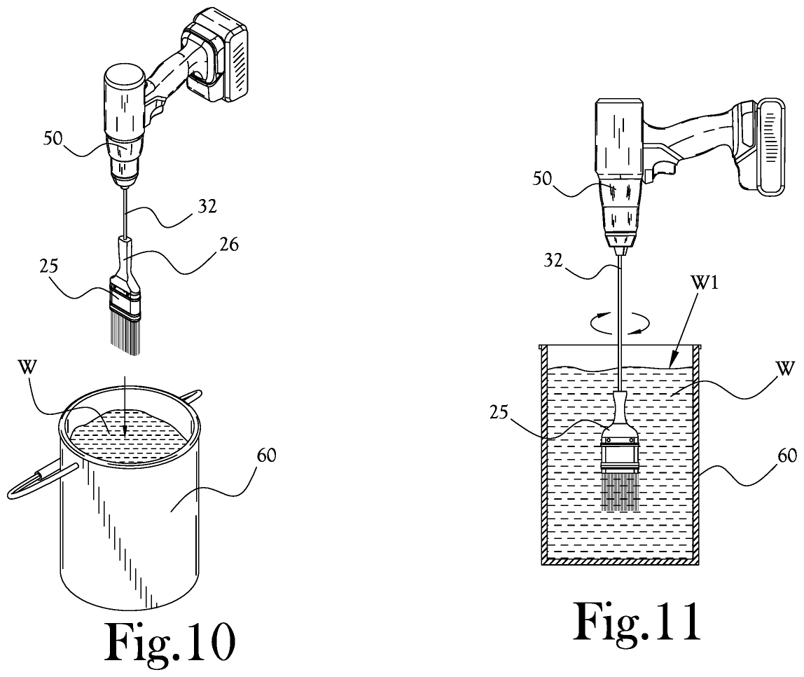

FIGS. 9A and 9B present perspective views of a paint brushes adapted to work with an example embodiment assembly according to example embodiments of the present general inventive concept; as shown in the Figures, the example embodiments are substantially identical, except that the example embodiment 25a shown in FIG. 9A includes a extender shaft or spindle 32 that is notably longer than the extender shaft or spindle 34 of the in the example embodiment 25b shown in FIG. 9B. Otherwise, in both embodiments, the paint brushes includes a handle 26, a ferrule 27, and bristles 28. FIG. 10 presents a perspective view showing example embodiment paint brush 25, connected via the shaft 32 to a drill or rotator 50 and proximate a bucket 60 partially filled with water W, with the paint brush 25 about to be immersed in the water W within the bucket 60, and FIG. 11 is a section view, showing the paint brush 25 and a portion of the extender shaft or spindle 32 immersed in the water W within the bucket 60.

In various example embodiments, assemblies and methods according to the present general inventive concept also have applications for use with painting instruments other than or beyond rollers. As illustrated in FIGS. 10 and 11, the paint brush 25 is adapted to work within an assembly according to the present general inventive concept by having a spindle 32 attached to and extending from a distal end of the handle 26, as shown in FIG. 9A. That is, the spindle 32 extends from an end of the handle 26 that is opposite the end of the handle 26 where the handle 26 meets the ferrule 27. One end of the spindle 32 is adapted to be received by the chuck of a drill 50, as shown in FIG. 10. As further illustrated in FIG. 10, the adapted paint brush 25, connected by the spindle 32 to the drill 50, is positioned proximate a bucket 60 partially filled with water W, with the paint brush about to be immersed in the water W within the bucket 60. FIG. 11 is a section view of the example embodiment shown in FIG. 10, showing the paint brush and a portion of the extender shaft immersed in the water W within the bucket 60, with the entire paint brush 25 immersed beneath the surface W1 of the water W in the bucket 60. The drill 50 is then used to spin the spindle 32 and the paint brush 25 attached to the spindle 32, and the spinning of the paint brush 25 within the water W acts to clean the paint brush 25, removing paint and other extraneous material from the paint brush 25.

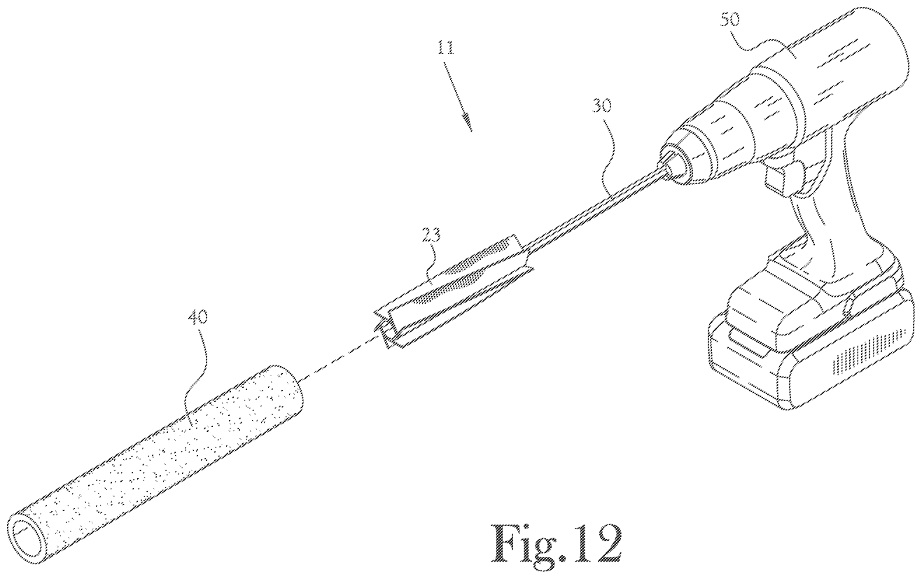

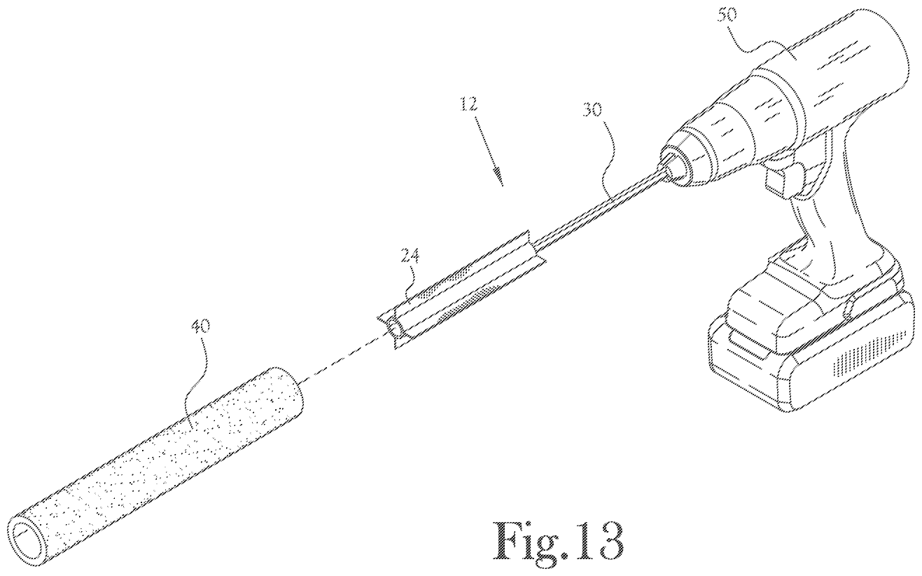

FIG. 12 and FIG. 13 show further example embodiments of the present general inventive concept, showing an assembly with a roller frame and extender shaft used with an electric screwdriver, wherein the roller frame comprises a solid molded body with a central axial portion configured to fit on or with the extender shaft and with a plurality of wings radiating from the central axial portion. FIG. 12 shows an embodiment 11 in which the wings radiate from the central axial portion of the roller frame 23 in a spiral configuration, while FIG. 13 shows an embodiment 12 in which the wings radiate from the central axial portion of the roller frame 24 in a substantially orthogonal configuration. Obvious modifications and variations will be apparent to those of skill in the art and are also encompassed by the present general inventive concept. In various embodiments, the roller frame solid molded body is fabricated from a hard plastic or from a similar material or from a material exhibiting similar physical properties.

Various example embodiments of the present general inventive concept provide a paint roller cleaner that passes through and is configured to be stored within the roller, thereby making the paint roller cleaner and the roller easy to ship and/or sell as a combination, as well as occupying less space to display in-store. The spindle portion is locked to the roller frame. With assemblies according to the present general inventive concept, it takes only a minute (approximately) to clean a dirty roller in ten inches of water within a five-gallon bucket. The roller emerges from the cleaning process ready for the next color of paint.

In various example embodiments, assemblies and methods according to the present general inventive concept also have applications for mixing paint, as well as for mixing drywall mix and similar materials.

The foregoing description of preferred embodiments of the present disclosure has been presented for purposes of illustration and description. The described preferred embodiments are not intended to be exhaustive or to limit the scope of the disclosure to the precise forms disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A roller spinning assembly for cleaning a paint roller, comprising:
a roller frame, and
a spindle connected to the roller frame,
said roller frame being adapted to interact with a paint roller such that at least some portion of the paint roller fits over the roller frame, and one end of the spindle being adapted to be received by a chuck of a drill,
the spindle being locked to the roller frame such that the spindle does not rotate independently of the roller frame.

2. The roller spinning assembly according to claim 1 wherein said roller frame includes a solid molded body including
a central axial portion configured to fit with the spindle and
a plurality of wings radiating from the central axial portion.

3. The roller spinning assembly according to claim 2 wherein the wings radiate from the central axial portion of the roller frame in a spiral configuration.

4. The roller spinning assembly according to claim 2 wherein the wings radiate from the central axial portion of the roller frame in a substantially orthogonal configuration.

5. A method of cleaning a paint roller comprising:
providing a roller frame and a spindle connected to the roller frame, the roller frame is adapted to interact with a paint roller such that at least some portion of the roller fits over the roller frame, one end of the spindle being configured to be received by the chuck of a drill, and the spindle being connected to the roller frame such that the spindle does not rotate independently of the roller frame;
fitting the roller is onto the roller frame;
fitting the spindle is to the drill;
immersing the roller, roller frame, and a portion of the spindle in water within a bucket; and
spinning the spindle by activating the drill, whereby the spinning of the roller within the water acts to clean the roller quickly, removing paint and other extraneous material from the roller.

6. A method of cleaning a paint brush comprising:
connecting a paint brush with a handle to a spindle, one end of the spindle being configured to be received by the chuck of a drill, and the spindle being connected to the handle of the paint brush;
fitting the spindle is to the drill;
immersing the brush and a portion of the spindle in water within a bucket; and
spinning the spindle by activating the drill, whereby the spinning of the brush within the water acts to clean the brush quickly, removing paint and other extraneous material from the brush.
